(19) United States
(12) Patent Application Publication
(10) Pub. No.: US 2010/0021663 A1
(43) Pub. Date: Jan. 28, 2010

(54) Synthetic fiber fabric for the manufacture of sausage casings

(76) Inventor: Jürgen Thiele, Augsburg (DE)

Correspondence Address: KLAUS J. BACH, 4407 TWIN OAKS DRIVE, MURRYSVILLE, PA, 15668, US

(21) Appl. No.: 12/460,674

(22) Filed: Jul. 22, 2009

(30) Foreign Application Priority Data
Jul. 23, 2008 (DE) 20 2008 009 937.4

(51) Int. Cl. A22C 13/00

(52) U.S. Cl. 428/34.8

(57) ABSTRACT

A synthetic fiber fabric for the manufacture of casings for sausages and other meat products consisting essentially of 100% synthetic fibers which are treated by alkalinization or if the synthetic fibers consist of an alkaline resistant material, by an acid solution so that the fabric fibers are modified to render the fabric absorptive to water and additional compounds such as flavor enhancers, smoke flavors, salts or others.

### BACKGROUND OF THE INVENTION

For sausage casings, specifically for ham packings currently plyester-viscose mixtures and pure viscose and also pure cotton materials are used.

In this connection, structures are for example used which consist of yarn including 85% viscose and 15% polyester, wherein both fibers are intimately mixed in the yarn. They may also consist of 100% viscose fibers or 100% cotton fibers. Both yarns which are used in these fabrics are always spun yarns.

In connection with the materials used so far, it is disadvantageous that, as far as it concerns the viscose manufacture in the preferred supplier countries in Asia, in particular, China, there are substantial concerns because of a manufacture which is extremely polluting the environment. Furthermore, a consistent quality of such materials is difficult to obtain since, because of price considerations, only very low quality fibers are used so that the technical characteristics such as yarn thickness, rupture strength and rupture stress values, twisting and number of individual filaments are subject to large variations. This applies basically also to higher quality vicose fibers since it always involves spun yarn for which an absolute uniformity cannot be achieved for processing reasons. Viscose also has the disadvantage that during scalding, particularly at the scalding temperature, it has a greatly reduced wet tensile strength.

In connection with cotton fibers, the problem of freedom of toxicity arises which in connection with the type of fibers can be obtained basically only by expensive procedures and never to a full hundred percent, because by growing of cotton in monocultures, the presence of pesticide residues and fertilizer residues as well as other contaminants is unavoidable. This, however, also applies to vicose fibers, where other residues may be generated by a rather problematic manufacturing procedure. Since the sausage casings are food packings, any content of noxious compounds in the materials is highly problematic.

Furthermore, all spun yarns must always be treated by finishing as pretreatment for weaving. Because of the hairy composition of the yarns used, large production volumes must be used. The only government-approved finishing medium, that is starch, additionally makes the yarn stiff and brittle. This negatively affects the efficiency as well as the weaving error susceptibility.

The starches used as finishing compounds are manufactured mainly from corn or potatoes. Because of the universally expanding use of gene-manipulated plants in this area, it becomes more and more difficult to comply with the requirement to use only starches which are free of any gene manipulations. A 100 percent removal of toxic compounds from the large amount of starches used is difficult and cannot always be guaranteed.

DE 10 2005 020 964 A1 discloses a fat-tight food casing for use as sausage casing which consists of a textile carrier material that is coated at the inside with a layer of regenerated or precipitated cellulose. Herein the carrier material consists of natural fibers such as cotton, linen, stable fiber, wool and/or silk and/or synthetic fibers such as polyester, polyimide, polyolefin and other polymers. The artificial sausage casing manufactured therefrom should be mechanically stable and in particular, should have a greater wet tensile strength and, on the other hand, should also be fat-tight. The above comments consequently also apply to these known artificial sausage casings.

It is the object of the present invention to overcome the problems pointed out above, particularly to overcome the problematic toxic material content or toxic material adherence to viscose or cotton fibers as well as the problem of using starches as finishing medium. In this connection, the most important criterion to be considered is that the fabric also has the capability to take up chemicals such as taste enhancers, smoke flavors, salts, etc., in the common scalding procedures. It is exactly this capability which is normally not provided by synthetic fibers and the synthetic fiber fabrics manufactured therefrom.

### SUMMARY OF THE INVENTION

In accordance with the invention, a fabric for the manufacture of sausage casings which is usable particularly also for the packings of ham is provided which consists to 100% of synthetic filament fibers since these fibers have substantial advantages as far as purity and uniformity is concerned for the whole processing chain. At the same time, it is made possible thereby to guarantee compliance of 100% with the official food quality requirements. Another advantage is that the materials are also of interest on a cost basis.

A synthetic fiber fabric for the manufacture of casings for sausages and other meat products consisting essentially of 100% synthetic fibers which are treated by alkalization or if the synthetic fibers consist of an alkaline resistant material, by an acid solution so that the fabric is modified to render it absorptive to water and additional compounds such as flavor enhancers, smoke flavors, salts or others.

The feature according to the invention is in the form, and has the properties, needed to be suitable for use as sausage casings and ham packings.

These properties include freedom from contamination by toxic materials as they may be contained in cotton fibers as a result of fertilization or treatment of the cotton plants. Such contaminations are not present in synthetic fibers because of the fully synthetic manufacture of the fibers used.

Those properties also include the capability of the fabric to take up and bind water and other materials. It is noted that the manufacture of sausage- and ham products comprises the application of certain chemicals such as flavor enhancers, smoke flavors, salts etc., to the fabric used as sausage casing or ham packings, whereupon the sausage or ham products are subjected to scalding in order to transfer these chemicals to the interior that is to the sausage or ham meat material during scalding in a controlled manner.

Such chemicals are applied by the user of the fabric wherein first one fabric side which subsequently will be the outside of the packing is coated with acrylate in order to ensure the water and air permeability of the finished packing, and then chemicals are applied to the other side of the fabric which then becomes the inner side of the finished packing so that, during scalding, the chemicals permeate int the sausage or the ham material.

The properties referred to include further a suitable elasticity and shrink capability. For use as sausage casings or ham packings, a hose is formed from the fabric. During filling the hose is first stretched. Upon drying, after scalding the filled-in goods that is, the sausage or ham material shrinks and the fabric needs to follow this shrinkage. Stretching and shrinking capabilities however need to be present only in the transverse system, that is, in the woof yarn. But in the longitudinal, that is in the wrap yarn, a high wet stress capability is needed since the scalding occurs in long scalding lines in which the sausages being scalded are still interconnected and ripping must not occur at that point.

Insufficient stretching capability or respectively, insufficient shrink behavior and insufficient water- or, respectively, chemical absorption capability may in the past have been the reason for not considering pure synthetic yarns for sausage casings and ham packings. Mainly however, the synthetic fibers do normally not have the capability to absorb any flavor material and to pass it on to the goods being scalded. This capability is acquired by the synthetic fiber fabric only by the special treatment in accordance with the present invention.

The present inventor has developed a fabric which has the desirable properties mentioned above: This fabric consists for example of 100% polyester filament yarns. The polyester filaments of which these yarns consist are—in contrast to the conventionally used fibers—endless filaments so that the yarns are not spun yarns. The yarns used herein are therefore absolutely fully uniform, in contrast to spun yarns. The fabric according to the invention may comprise for example polyester filament yarns with 75 den textured in the warp and of polyester filament yarns of modified polyester (polybutylene-teraphalat) with 75 den in the woof. The woof yarn has the advantage that it provides for the required stretching and the necessary back shrinking in the above mentioned manufacturing process of sausage and ham products.

The fabric according to the invention is woven in the conventional manner. If finishing of the yarn consisting of endless filaments is desired no starch materials are needed for this purpose as it is necessary with the conventional fabrics but finishing can be performed using acrylate.

After conventional pre-treatment procedures, the fabric is subjected to an alkalization step in which the fabric is exposed under time and temperature-controlled conditions to a highly concentrated alkaline solution preferably on the basis of a caustic soda solution whereby the surface of the individual filaments is modified. Craterlike cavities are formed thereby in the filament surfaces. In this way, the soaking up of water or chemicals is greatly accelerated; the water and chemicals can be retained in these spaces formed by the procedure. In this way, the required property of the fabric to accommodate and retain chemicals of the type mentioned above, that is, flavor enhancers, smoke flavors, salts etc., is obtained and those can be transferred during the following scalding procedure to the sausage or ham product.

Since pure polyester fibers normally cannot absorb and retain any water or any compounds dissolved in water the alkalization step is necessary in order to make the fabric suitable for the manufacture of sausage casings. The stretch and shrink capability of the woof yarn is not negatively affected by the alkalization step. The high tensile strength which is mainly important for the warp yarn (in longitudinal direction) is somewhat reduced but that strength can be adjusted by a suitable selection of the number of filaments and the filament thickness.

The following modifications are also possible:

Instead of the polymer yarn, an alkali-resistant spandex polyester mixture yarn may be used which provides for even greater shrinkage possibilities. In this yarn, a polyester yarn is combined with a spandex-rubber in which for example alternately polyester filaments and spandex filaments are used.

Also, with highly twisted polyester filament yarn (for example, twisted at 1650 rpm) similar effects may be obtained.

The various variants offer different advantages. Also, as a result, a wide variety of requirements for different sausage/ham filling goods may be considered.

Similar effects can be achieved also with polyamide yarns. In this case, however, instead of a caustic soda solution, a follow-up treatment by strong acids must be used which provide for a result similar to that described in connection with the alkalization process in order to obtain the capability of the fabric to absorb and retain water and flavor compound, salt etc.

What is claimed is:

1. A synthetic fiber fabric for the manufacture of casings for sausages and other meat products, consisting of 100% synthetic fibers, the fibers being surface-treated by one of alkalization and, if the plastic of which the fibers consist is alkaline-resistant, by acid treatment to modify the fiber surface so as to render the fabric absorptive for water and other compounds including flavor enhancers, smoke flavors and salts.

2. A synthetic fiber fabric according to claim 1, wherein filament yarns used in the fabric are endless filaments.

3. A synthetic fiber fabric according to claim 1, wherein the synthetic filament fibers consist of polyester.

4. A synthetic fiber fabric according to claim 4, wherein the fabric is alkalinized by a caustic soda solution.

5. A synthetic fiber fabric according to claim 1, wherein the fabric consists of a spandex-polyester mixture including a polyester yarn combined with a spandex rubber.

6. A synthetic fiber fabric according to claim 5, wherein the fabric includes alternately polyester filaments and spandex filaments.

7. A synthetic fiber fabric according to claim 1, wherein the fabric consists of polyamide fibers.
